(19) United States
(12) Patent Application Publication
(10) Pub. No.: US 2007/0109234 A1
(43) Pub. Date: May 17, 2007

(54) LIQUID CRYSTAL DISPLAY AND METHOD FOR DRIVING SAME

(76) Inventors: Tzu-Wei Ho, Fengshan (TW); Cheng-Pang Chien, Hsin-Chu City (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/423,152

(22) Filed: Jun. 9, 2006

(30) Foreign Application Priority Data
Nov. 11, 2005 (TW) 094139830

(51) Int. Cl. G09G 3/36

(52) U.S. Cl. 345/87

(57) ABSTRACT

A LCD display method capable of over-driving the LCD panel of small, portable electronic apparatus is proposed. The display method includes the steps of: storing the input image data into a first random access memory (RAM); synchronously comparing a current image frame stored in the first RAM with a previous image frame stored in the second RAM; normally driving or over-driving a plurality of LCD pixels in accordance with the comparison result, wherein while a picture element of the current image frame is darker than the one positioning the same in the previous image frame, over-driving its corresponding LCD pixel; and copying the image data of current image frame stored in the first RAM to the second RAM for being the comparison reference of the next image frame.

### BACKGROUND OF THE INVENTION

1. Field of the Invention

The present invention relates to a Liquid Crystal Display (LCD), and more particularly to a LCD display method and system thereof to over-drive the LCD monitor in a small portable electrical product.

2. Description of the Prior Art

Response time is an important issue to distinguish the quality of the Liquid Crystal Display (LCD) monitor. Response time is showing the interval between the signal switching time and the mode switching time within the LCD monitor. It also can be seen as the response speed in each pixel of the LCD monitor after signal is inputted. In addition, the response time is the wasting time during the process of the light switching. Comparing to the Cathode Ray Tube (CRT) monitor, the pixel of the LCD monitor has a longer response time during the monitor from light to dark or from dark to light. During the picture switching, the previous picture cannot be immediately disappeared and it is like a shadow still left in the monitor. When you are watching the sports car racing, motion movies or playing the TV games, the shadows will affect the quality of the pictures if the response time is not fast enough.

Generally, the performance of the images in the LCD monitor is better if the response time is shorter and the response speed is faster. Therefore, every large LCD manufactories had tried their best to improve the response time of the LCD monitor. There are four major methods to decrease the response time in LCD pixel: decreasing the viscosity coefficients of the liquid crystal materials, increasing the dielectric coefficients of the liquid crystal materials, reducing the interval between the liquid crystal cells and increasing the liquid crystal threshold voltage. The first two methods are about improving the material's quality and the last two methods are about the manufacture and the design of the LCD circuit.

The technique of over-driving is used to increase the liquid crystal threshold voltage to reduce the response time. By changing the timing controller (T-con) and the liquid crystal threshold integrated circuit (IC), the LCD reverse voltage will increase and the LCD pixels will quickly reverse and recover.

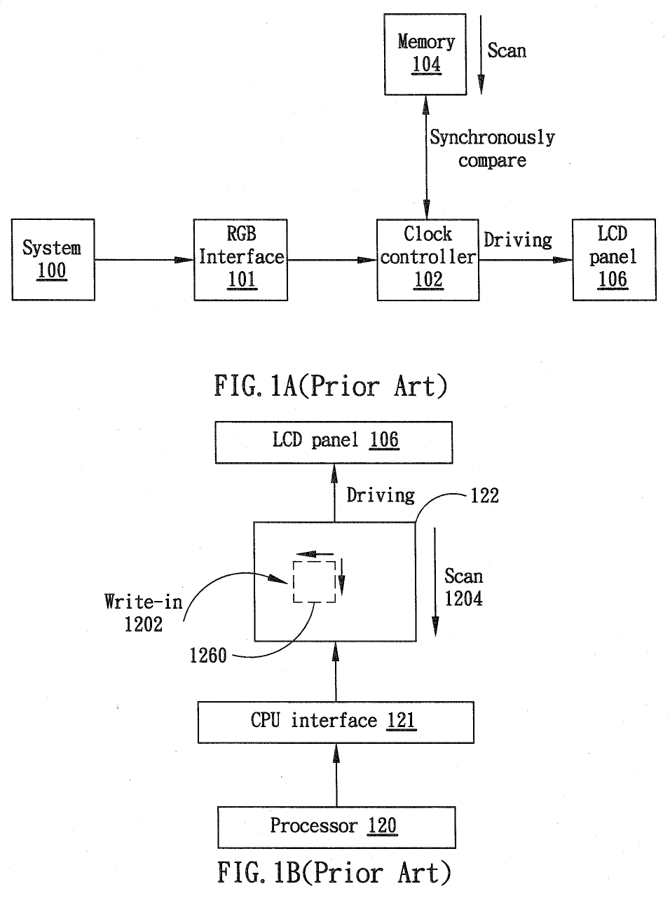

Now referring to FIG. 1A, it is a simple diagram about a LCD display system using over-driving technique. The picture image is passed through the Red Green Blue (RGB) interface 101 from the system 100 (such as a video card in the computer system), and then is not outputted and over driven the LCD panel 106. By the timing controller 102, each of the picture images is synchronously compared to each of the previous frame image data, which is saved in the memory 104 (such as synchronous dynamic random access memory, SDRAM). When the present picture image, which is going to display, is too dark, it is going to over drive the LCD pixel, which is corresponding to the picture image.

However, the system structure described above is not suitable to the LCD monitor in the small portable electrical product, such as cell phone, personal digital assistant (PDA) and so on. Because the small portable electrical product is usually designed to save the power, the image data transmitted interface of the small portable electrical product is not like the RGB interface used in the computer system and synchronously inputs image data into the LCD display board. The small portable electrical product uses the asynchronous data transmitted interface, such as center processor unit (CPU) interface, to partially write/update new picture image data and in order not to waste more power during the data transmitting. As shown in FIG. 1B, the image data of the processor 120 is written in the memory 122 from the CPU interface 121. The write-in 1202 of the image data and the scan 1204 of the image output are not synchronous. Besides, where to write and when to write in the image data 126 are not stable, the over-driving operation of the LCD system described above cannot be used in the portable electrical products.

### SUMMARY OF THE INVENTION

As the description above, the structure of the prior art cannot be used in the over-driving of the portable electrical products. The purpose of the present invention is to provide a display method and system of the liquid crystal display device. The response time can be reduced by utilizing the over-driving technique in the portable electrical products and then the performance of the picture will be better.

A LCD display method and system thereof is provided in the present invention and comprises the following steps: saving a first image data in a first random access memory (RAM); receiving a second image data by an asynchronous image interface and writing and saving the second image data in a second RAM; synchronously comparing the first image data of the first RAM and the second image of the second RAM; outputting a controlled signal according the synchronously compared result; duplicating the second image data of the second RAM in the first RAM and updating the first image data. The image data is asynchronously written in the first RAM by an asynchronous image interface, especially a CPU interface. The synchronously compared step is controlled by an internal clock controller.

A display system of the LCD monitor is further provided in the present invention and comprises: a first RAM used to save a first image data and the external input image data is temporary written in the first image RAM; a second RAM is used to save a second image data; an asynchronous image interface is used to asynchronously input the image data and save it in the second RAM; a compared device is used to synchronously compare a plurality of pixels corresponding to the first and the second image data; and an over-driving circuit used to drive or over-drive a plurality of pixels according to the compared result. The first image data is the image data of the previous frame and the second image data is the image data of the present frame.

### BRIEF DESCRIPTION OF THE DRAWINGS

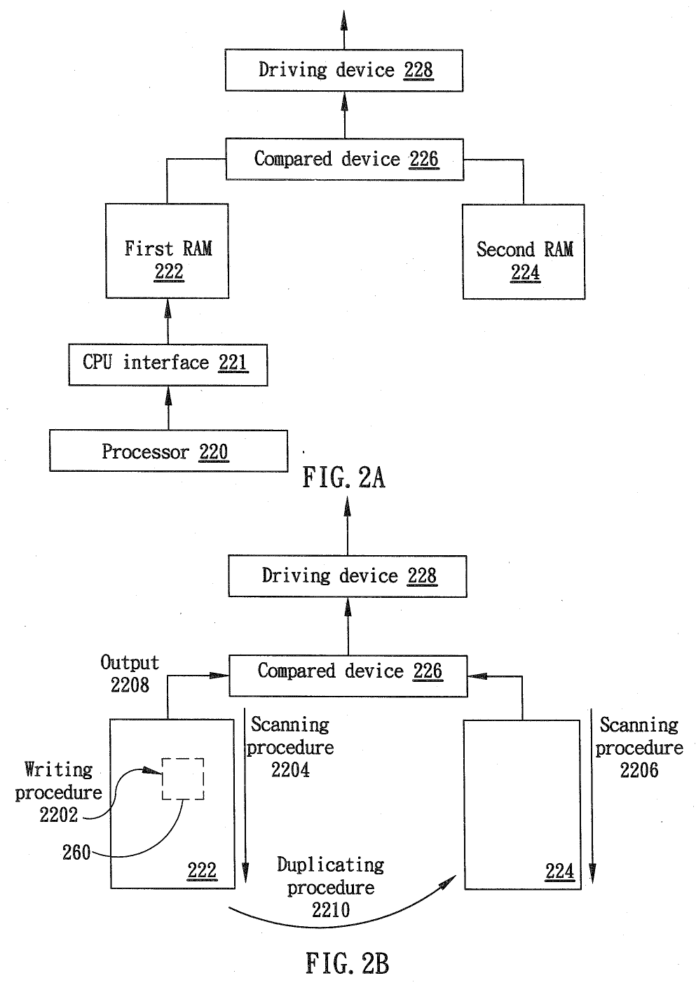

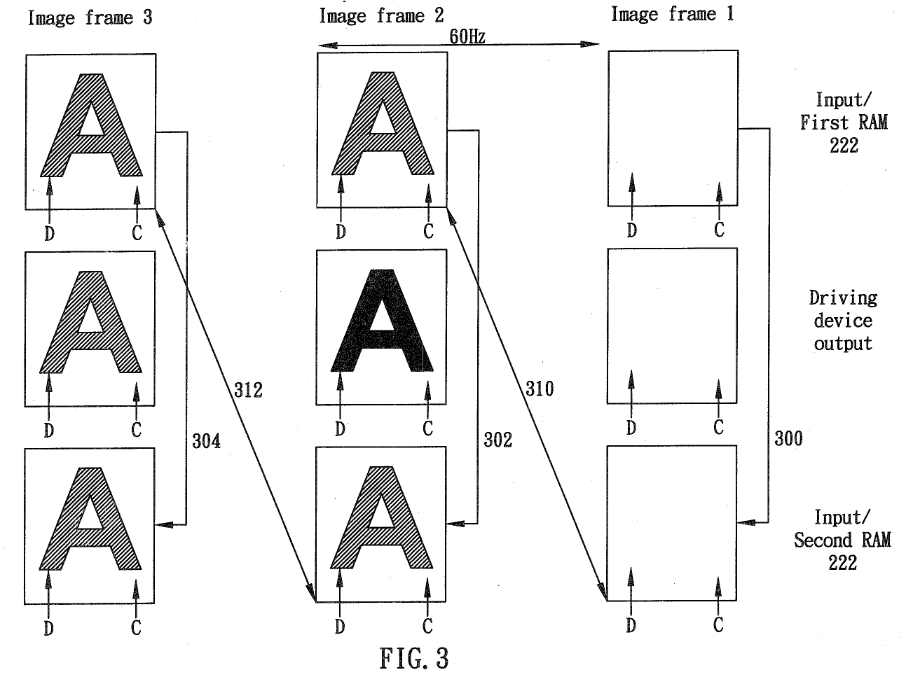

The foregoing aspects and many of the attendant advantages of this invention will become more readily appreciated as the same becomes better understood by reference to the following detailed description, when taken in conjunction with the accompanying drawings, wherein: FIG. 1A is a simple diagram about a LCD system using over-driving technique. FIG. 1B is a flowchart showing how the over-driving technique works in the LCD monitor in the prior art. FIG. 2A is a diagram illustrating a preferred embodiment of the present invention of a LCD display method and system thereof used in a portable electrical product. FIG. 2B is a flowchart showing how the over-driving technique works in the LCD monitor in the present invention. FIG. 3 is a flowchart showing how to process the continuous image frame in the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

FIG. 2A is a diagram illustrating a preferred embodiment of the present invention of a LCD display method and system thereof used in a portable electrical product. The first random access memory (RAM) is used to receive the image data. The processor 220 asynchronously inputs the image data from the center processor unit (CPU) interface 221 and the image data is written in the first RAM. The second RAM is used to save the previous image data provided for the need of the over-driving operation. The compared device 226 is working like a T-con used to synchronously compare the first image data saved in the first RAM 222 and the second image data saved in the second RAM 224. Then, the compared device 226 outputs a control signal according to the compared result and the control signal was transferred to the driving device of the LCD. Finally, the second image data saved in the second RAM 224 is duplicated in the first RAM 222 and will update the first image data. The driving device 228, such as gate driver, is used to drive the LCD display image picture. In the regular operation, the driving device is used to provide the nominal voltage for the LCD cell and the display pixel. When the display pixel is satisfied the condition to over-drive, the driving device 228 provides a larger voltage to over-drive the LCD pixel corresponding to the display pixel. There are two RAMs included in the present embodiment, which is different to the previous technique structure.

According to the description above, referring to FIG. 2B, the inputted image data 260 is randomly written in the first RAM. In one embodiment, a complete image picture saved in the first RAM 222, which is an image frame of the image data. The output 2208 of the first RAM 222 is the output of the present image frame controlled by the internal clock controller (not shown) of the system. The image data generated by the scanning procedure is sequentially saving in the first RAM 222. When the scanning procedure has scanned the first RAM 222, an image frame of the image scanning procedure is done.

It should be noted that the writing procedure 2202 and the scanning procedure 2204 in the first RAM 222 need some rules to avoid accessing the same pixel of the image data at the same time. In one embodiment, the memory address of a plurality of pixels, which has not been scanned by the scanning procedure 2204, is set to forbid the data writing. After the scanning procedure 2204 finished scanning the corresponding memory address, the data image can be written into the first RAM 222. This method is simple and can be practiced by controlling the internal clock controller to forbid accessing some memory address in some specific time. The structure how to access the same memory in the same time is known by those people skilled in the art, it is not necessary to describe here again.

The LCD system in the present invention is different to the LCD system in the prior art, and the LCD system in the present invention is not directly accessed the output 2208 of the image data in the first RAM 222 to drive the LCD panel. The image data of the present invention is used to compare each pixel with the previous image frame of the image data saved in the second RAM 224, before outputting in the front of the LCD board and then process the over-driving operation. The scanning procedures 2204 and 2206 are synchronous. The previous image frame of the image data saved in the second RAM 224 can be duplicated to the first RAM 222 (the duplicating procedure 2210) at the time or after the time when the scan procedure of the first RAM is in operating. For example, when the scanning procedure 2204 has scanned an image frame, the data saved in first RAM 222 is duplicated to the second RAM 224 and will be the reference for the next picture.

The compared device sequentially compares the image date of the present image frame and the previous image frame and decides a LCD pixel, which is corresponding to image pixel, to do the over-driving operation. The image data can be compared by a pixel, a scanned line, or a block. The driving device 228 is going to drive the LCD board according to the result from the compared device 226. The LCD pixel, which is satisfied the condition when the brightness of the present image frame pixel is brighter than the previous image frame, is doing the over-driving operation and is given a bigger voltage. In the rest of the time, the operation is normal.

The flowchart of the present invention is showing in FIG. 3. There are three image frames in the figure. The top row is the first RAM 222 and the inputted picture image data is saved in it. The bottom row is the second RAM 224 used to save the previous picture image data. The middle row is the output of the driving device 228.

At the beginning, in the image frame 1, there is no picture saved in the first RAM 222. And there is no previous image frame information saved in the second RAM 224. Therefore, the output of the driving device directly displays the empty screen. After scanning the image data of the first RAM 222, the image data will be automatically saved in the second RAM 224 by the system for the reference of the comparison of the next picture.

Between the time interval of the image frame 1 and the image frame 2, if there is an image data, such as the English Alphabet A of the image frame and the brightness of which is 128, written in the first RAM 224, the system will compare the picture of the first RAM 222 and the image frame 1 of the second RAM 224 to decide what the output is in the image frame 2 (step 310). In the C, D points of the picture, the brightness of the pixel of the point C is the same in the image frame 2 and in the previous image frame, so the output of point C won't do the over drive operation. The point D is the pixel of Alphabet A and is darker than the pixel of the previous image frame, and the point D is doing over drive in the output. Generally, the Alphabet A will be output if the picture is darker than the previous image frame. Then, the system will duplicate the image data, which is saved in the first RAM 222, to the second RAM 224 (step 312).

In the image frame 3, the image data inputted by the first RAM 222 is the same as the picture in the image frame 2. The points C and D are compared with the previous image frame (step 312) and are not satisfied the condition of the over drive. The drive device won't do the over drive output in the image frame 3. And the image data saved in the first RAM is duplicated to the second RAM 224 (step 304).

According to the description above, an over-driving system of a liquid crystal display (LCD) used in a small portable electrical device is disclosed in the present invention and still comprises the structure with asynchronous transmission interface. Because of the design of the dual memory structure, the LCD panel of the small portable electrical device can do the over drive operation. In the preferred embodiment of the present invention, in FIG. 2A, the random access memories (RAM) 222 and 224, the compared device 226, and the driving device 228 can be integrated in one device (such as a driver integrated circuit (IC)). It should be noted that the electrical products are usually made by different companies and are consist of many different components. For example, the LCD panel, panel driver IC, processor, and mother board in the mobile phone are made by different manufacture. Therefore, the present invention can let the IC design manufacture (or LCD panel manufacture) design a new driver IC without changing the integral display system structure in the processor or motherboard. And the over drive operation in the LCD panel can shorten the response time of the LCD monitor.

Although specific embodiments have been illustrated and described, it will be appreciated by those skilled in the art that various modifications may be made without departing from the scope of the present invention, which is intended to be limited solely by the appended claims.

What is claimed is:

1. A method for driving an LCD having a plurality of pixels, comprising:
storing first image data;
receiving second image data synchronously comparing the first image data with the second image data;
outputting a control signal according to synchronously compared result; and
duplicating the second image data and updating the first image data.

2. The method according to claim 1, wherein the first image data is a previous image frame and the second image data is a present image frame.

3. The method according to claim 2, wherein synchronously comparing the first image data with the second image data comprises sequentially reading a plurality of pixels in the previous frame and a plurality of corresponding pixels in the present image frame according to a clock signal.

4. The method according to claim 1, wherein the LCD is normally white.

5. The method according to claim 4, wherein when the pixel corresponding to the second image data is darker than the pixel corresponding to the first image data, the controlled signal over drives the pixel corresponding to the second image data.

6. The method according to claim 1, wherein the LCD is normally black.

7. The method according to claim 6, wherein when the pixel corresponding to the second image data is lighter than the pixel corresponding to the first image data, the controlled signal over drives the pixel corresponding to the second image data.

8. An LCD driving system, comprising:
a first random access memory (RAM) for storing first image data;
a second RAM for storing second image data;
a comparing device for synchronously comparing a plurality of pixels in the first image data with a plurality of corresponding pixels in the second image data, wherein after comparing the first image data with the second image data, the second image data is duplicated in the first RAM to update first image data; and
an over driving circuit unit for over driving a plurality of pixels according to compared result;

9. The LCD driving system according to claim 8, further comprising a clock generator circuit, wherein the comparing device is configured to compare the first image data with the second image data according to a clock generated by the clock generator circuit.

10. The LCD driving system according to claim 9, wherein the asynchronous image interface comprises a CPU interface.

11. The LCD driving system according to claim 8, wherein the first image data is a previous image frame and the second image data is a current image frame.
